(19) United States
(12) Patent Application Publication
(10) Pub. No.: US 2019/0198963 A1
(43) Pub. Date: Jun. 27, 2019

(54) RF WAVEGUIDE TWIST

(71) Applicant: ZTE CORPORATION, Shenzhen (CN)

(72) Inventors: Li ZHUO, Xi'an (CN); Zhiping Feng, Chapel Hill (CN); Edwin Nealis, Cary, NC (US); Ying Shen, Chapel Hill, NC (US)

(21) Appl. No.: 15/851,498

(22) Filed: Dec. 21, 2017

(51) Int. Cl. H01P 5/18

(52) U.S. Cl. CPC H01P 5/18

(57) ABSTRACT

A waveguide apparatus comprises an input port having a rectangular cross-section in a plane perpendicular to a direction of propagation. The rectangular cross-section has a short side and a long side. The waveguide apparatus further comprises a plurality of resonant cavities, coupled with the input port, including a first resonant cavity and a second resonant cavity diagonally disposed with respect to each other in the plane perpendicular to the direction of propagation. Each resonant cavity has a square cross-section in the plane perpendicular to the direction of propagation. The waveguide apparatus further comprises an output port coupled with the plurality of resonant cavities on a side opposite the input port. The output port has a rectangular cross-section with a short side and a long side, wherein the short side of the output port's cross-section is perpendicular to the short side of the input port's cross-section.

### TECHNICAL FIELD

This application relates generally to waveguide apparatuses that change the direction of propagation and/or the polarization of a transmitted wave.

### BACKGROUND

A rectangular waveguide is a type of transmission line commonly used to guide and transport electromagnetic (EM) waves. Because of their low loss, high power-handling capabilities, and simple structure, rectangular waveguides are used broadly in high-power and high-frequency applications (e.g., millimeter wave communication systems and satellite systems). The dominant mode in a rectangular waveguide is a TE10 mode, in which the polarization of the electric field lies along the short side of the waveguide's rectangular cross-section.

When building modern waveguide systems, to meet the overall mechanical constraints of the system, it is often necessary to change the propagation and polarization directions of the transmitted electromagnetic wave. But because rectangular waveguides are typically rigid, this is not straightforward. Additionally, waveguide bends (e.g., waveguide components that change the direction of propagation of the transmitted wave) and waveguide twists (e.g., waveguide components that change the polarization direction of the transmitted wave without changing the direction of propagation of the transmitted wave) must be designed with signal distortions, losses, and reflections in mind.

Accordingly, a conventional waveguide twist consists of a gradual rotation of the waveguide's cross-section to slowly change the polarization along the propagation direction. To avoid losses due to reflections, the length of a traditional waveguide twist is typically at least twice the wavelength of the transmitted signal (e.g., the wavelength at which the waveguide is designed to operate). As a result, traditional waveguide twists are quite long and bulky, especially at low frequencies. Further, it is impossible for a traditional waveguide twist to be manufactured by using standard milling processes due to its twisted shape.

### SUMMARY

Accordingly, there is a need for smaller waveguide structures (e.g., apparatuses) that change the directions of polarization and propagation of a wave transmitted through a waveguide (e.g., waveguide twists and waveguide bends, respectively), while simultaneously minimizing distortions and reflections. In addition, there is a need for waveguide twists and waveguide bends that are easy to fabricate.

To that end, a waveguide apparatus is provided. The waveguide apparatus comprises an input port, a plurality of resonant cavities, and an output port. The input port has a rectangular cross-section in a plane perpendicular to a direction of propagation. The rectangular cross-section has a short side and a long side. The plurality of resonant cavities is coupled with the input port. The plurality of resonant cavities includes a first resonant cavity and a second resonant cavity, where the first resonant cavity and the second resonant cavity are diagonally disposed with respect to each other in the plane perpendicular to the direction of propagation. Each resonant cavity has a square cross-section in the plane perpendicular to the direction of propagation. The output port is coupled with the plurality of resonant cavities on a side opposite the input port. The output port has a rectangular cross-section with a short side and a long side, wherein the short side of the output port's cross-section is perpendicular to the short side of the input port's cross-section.

In some embodiments, the input port is configured to receive a dominant TE10 mode and the output port is configured to output a dominant TE10 mode. For example, the input port and the output port may be symmetric (e.g., have the same dimensions).

In some embodiments, the waveguide apparatus further comprises a first waveguide coupled with the input port. The first waveguide has a rectangular cross-section that matches the input port. The waveguide apparatus further comprises a second waveguide coupled with the output port. The second waveguide has a rectangular cross-section configured to transmit a wave along a direction of propagation distinct from the direction of propagation along the first waveguide, and has a polarization distinct from a polarization of the first waveguide. The waveguide apparatus further comprises a waveguide bend coupling the output port with the second waveguide. The waveguide bend configured is to change the direction of propagation of the transmitted wave.

In some embodiments, the plurality of resonant cavities forms a waveguide twist. In some embodiments, the waveguide twist changes a polarization of a transmitted wave by 90 degrees. In some embodiments, a length of the waveguide twist is less than a wavelength of a transmitted wave at the waveguide apparatus's operating frequency. In some embodiments, the waveguide apparatus has dimensions smaller than 11 mm×11 mm×10 mm (e.g., for a bandwidth of 18 GHz to 25.75 GHz (K-band)).

In some embodiments, the input port, the plurality of resonant cavities, and the output port are formed from negative space in a pair of waveguide components mated together.

### BRIEF DESCRIPTION OF DRAWINGS

The accompanying drawings, which are included to provide a further understanding of the embodiments and are incorporated herein and constitute a part of the specification, illustrate the described embodiments and together with the description serve to explain the underlying principles. Like reference numerals refer to corresponding parts.

FIG. 1 is an assembled view of a waveguide apparatus with a waveguide twist, in accordance with some embodiments.

FIG. 2 is an assembled view of a waveguide apparatus with a waveguide twist and a waveguide bend, in accordance with some embodiments.

FIG. 3 is a perspective view of components that, when mated, form a waveguide apparatus from negative space, in accordance with some embodiments.

### DETAILED DESCRIPTION

Reference will now be made in detail to embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details.

As used herein, the term “direction of propagation” of a wave is the net direction of energy transfer by the wave.

As used herein, the term “polarization” or “direction of polarization” (e.g., of a transmitted wave) refers to the axis of orientation of the electric field of the transmitted wave.

In some instances, this disclosure refers to the polarization of a waveguide, which refers to the polarization of the dominant (e.g., primary) mode of the waveguide. In some embodiments, the waveguide is a rectangular waveguide and the polarization of the waveguide is the polarization of a TE10 mode. A TE mode refers to a transverse electric mode, in which the electric field is perpendicular to the direction of propagation. In rectangular waveguides, the TE10 mode is the TE mode with the lowest cutoff frequency.

Similarly, in some instances, this disclosure refers to the direction of propagation of a waveguide, which in many circumstances, is along the waveguide.

Unless otherwise stated, when used with respect to waveguide components, the term “cross-section” refers to the cross-section in the transverse plane (e.g., the plane perpendicular to the direction of propagation of the transmitted wave at that point along the waveguide component).

As used herein, the term “twist” (e.g., waveguide twist) refers to a waveguide component that changes the polarization of the transmitted wave without changing the direction of propagation of the transmitted wave in the waveguide.

As used herein, the term “bend” (e.g., waveguide bend) refers to a waveguide component that changes the direction of propagation of the transmitted wave. In some circumstances, a waveguide twist and a waveguide bend may be coupled together to effect a desired change in the direction of polarization and direction of propagation of the transmitted wave.

When geometrical terms such as “square” and “rectangular” are used herein, the operating principles of the apparatus can be understood in terms of that particular geometrical term. For example, a “square” cavity need not be perfectly square. For example, the interior corners of a square cavity may be rounded (e.g., because of the minimum radius of curvature for interior corners is set by the mill forming the cavity). As another example, one side of the square cavity can be shorter than the other, as long as the difference does not meaningfully affect the operation of the cavity as a “square” cavity (e.g., if the difference is less than one sixteenth of the operating wavelength). In addition, a square cavity may have rounded interior edges if, for example, such rounded edges simplify the manufacturing process (e.g., the milling process).

As used herein, a portion of a waveguide or wave coupling device is “formed” into a component (e.g., a larger component) when that portion of the waveguide is provided by the shape of the component (e.g., the portion of the waveguide is machined or otherwise shaped into the larger component).

The present disclosure provides a waveguide apparatus with a waveguide twist, which changes the polarization of the waveguide from a first polarization at an input port to a second polarization at an output port. In some embodiments, a rectangular waveguide is fed into a pair of square resonant cavities, disposed diagonally with respect to one another in a plane perpendicular to the direction of propagation of the incoming rectangular waveguide. The dominant mode for the rectangular waveguide is a TE10 mode. When the TE10 mode propagates from the input port through the pair of square resonant cavities, the polarization is rotated (e.g., 90 degrees) with respect to the incoming rectangular waveguide, thus changing the direction of polarization of the transmitted wave. For example, the polarization of the waveguide may be altered from a horizontal polarization to a vertical polarization of vice-versa. The inventors have found that a waveguide twist constructed in this way can be made substantially shorter than traditional waveguide twists, in which the rectangular waveguide is literally twisted along its length.

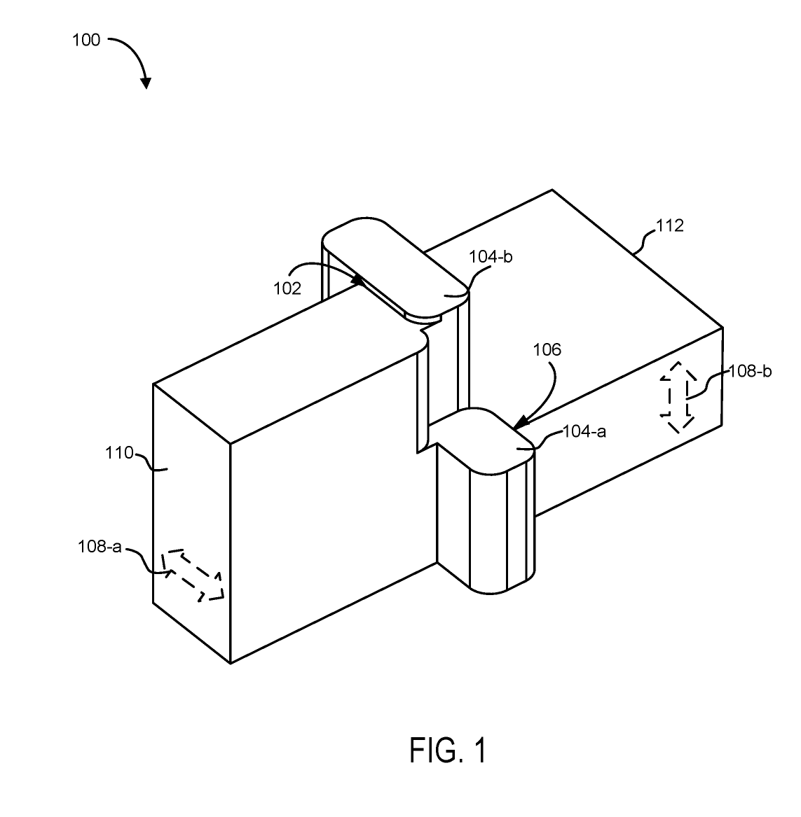

To that end, FIG. 1 is an assembled view of a waveguide apparatus 100 with a waveguide twist. The waveguide apparatus 100 comprises an input port 102, which has a rectangular cross-section in a plane perpendicular to a direction of propagation. The rectangular cross-section has a short side and a long side. In some embodiments, the polarization of the waveguide through the input port 102 is along the short side of the rectangular cross-section (e.g., the dominant mode is a TE10 mode). For example, the polarization of the waveguide may be horizontal, as shown by polarization arrow 108-a. In some embodiments, the polarization of the waveguide is dependent on the orientation of the input port. For example, the polarization of the waveguide may be vertical (e.g., if the short side of the input port is vertical).

The waveguide apparatus further comprises a plurality of resonant cavities 104 that are coupled with input port 102. In some embodiments, the plurality of cavities consists of a pair (e.g., two) cavities. For example, the plurality of resonant cavities includes a first resonant cavity 104-a and a second resonant cavity 104-b. Alternatively, the plurality of resonant cavities includes more than two cavities. In some embodiments, the first resonant cavity 104-a and the second resonant cavity 104-b are diagonally disposed with respect to each other in the plane perpendicular to the direction of propagation. For example, the first resonant cavity 104-a and the second resonant cavity 104-b are co-planar. In some embodiments, the first resonant cavity 104-a and the second resonant cavity 104-b are identical (e.g., the same size and/or dimensions). In some embodiments, each resonant cavity 104 (e.g., first resonant cavity 104-a and second resonant cavity 104-b) has a square cross-section in the plane perpendicular to the direction of propagation. In some embodiments, cavity 104-a and cavity 104-b overlap, so that the plurality of cavities 104 has a cross-section of two squares overlapping on the diagonal. In some embodiments, the plurality of resonant cavities 104 forms a waveguide twist. In some embodiments, the waveguide twist changes a polarization of a transmitted wave by 90 degrees. In some embodiments, the waveguide twist changes a direction of polarization of the transmitted wave without changing the direction of propagation of the transmitted wave. In some embodiments, a length of the waveguide twist is less than a wavelength of a transmitted wave at the waveguide apparatus's operating frequency. In some embodiments, the waveguide apparatus has dimensions smaller than 1 mm×11 mm×10 mm (e.g., for K-band).

In some embodiments, the waveguide apparatus further comprises an output port 106 that is coupled with the plurality of resonant cavities 104 on a side opposite the input port 102. For example, the output port 106 may be coupled on the other side of the resonant cavities 104 compared to where the input port 102 is coupled to the resonant cavities 104. In some embodiments, the output port 106 has a rectangular cross-section with a short side and a long side. The short side of the output port 106's cross-section is perpendicular to the short side of the first input port 102's cross-section. For example, where the output port and the input port are rectangles having the same dimensions, the output port may be oriented at a 90-degree angle compared to the orientation of the input port 102. In some embodiments, the direction of polarization of the waveguide is changed. For example, the polarization of the waveguide may be rotated by 90 degrees. For example, the polarization may change from a horizontal direction to a vertical direction or from a vertical direction to a horizontal direction. For example, the input port 102 may be oriented such that the polarization along the short side of the rectangle is vertical instead of horizontal.

In some embodiments, an RF signal with horizontal polarization from the waveguide at input port 102 is coupled to the plurality of resonant cavities (e.g., first resonant cavity 104-a and second resonant cavity 104-b). In the plurality of cavities, the orientation of the electric field vector and magnetic field vector are rotated. Through the plurality of cavities 104, the polarization of the transmitted wave is rotated by 90 degrees. In some embodiments, assuming the input port 102 couples-in a wave with a horizontal polarization, the output port 106 outputs a wave with a vertical polarization.

In some embodiments, the input port 102 matches to (e.g., is coupled with or receives) a first waveguide 110. For example, a transmitted wave may travel through first waveguide 110, through the input port 102, and continue through the plurality of cavities 104 and output port 106.

In some embodiments, the output port 106 matches to (e.g., is coupled with or receives) a second waveguide 112. The transmitted wave may travel through the output port 106 after passing through the plurality of cavities 104. As shown in FIG. 1, waveguide apparatus 100 twists the direction of polarization without bending the direction of propagation of the transmitted wave.

In some embodiments, the output port 106 is configured to output a dominant TE10 mode. In some embodiments, the output port 106 is configured to output a dominant mode that matches the dominant mode of the input port 102. For example, the rectangular cross-section of the input port 102 may be identical to the rectangular cross-section of the output port 106. In some embodiments, the input port 102 and the output port 106 are configured to output a dominant TE10 mode.

In some embodiments, the size of each cavity of the plurality of cavities is determined based on a frequency band. In some embodiments, each cavity is the same size. In some embodiments, each cavity has a square cross-section. For example, for a 23 GHz waveguide, the size of each cavity of the plurality of cavities has a side length of the square that is less than 11 mm.

In some embodiments, the length of the waveguide twist is smaller than one wavelength at the design frequency. For example, for a conventional waveguide, a waveguide is at least the length of two wavelengths. Thus, the present design is advantageous as it is smaller than a conventional waveguide. In some embodiments, the length of the waveguide twist is less than 10 mm for a 23 GHz band.

In some embodiments, the waveguide apparatus 100 is rotationally symmetric along one or more axes. For example, the waveguide apparatus may have two planes of symmetry along the direction of propagation, including a vertical plane of symmetry (e.g., the waveguide is symmetric about a y-axis) and a horizontal plane of symmetry (e.g., the waveguide is symmetric about an x-axis).

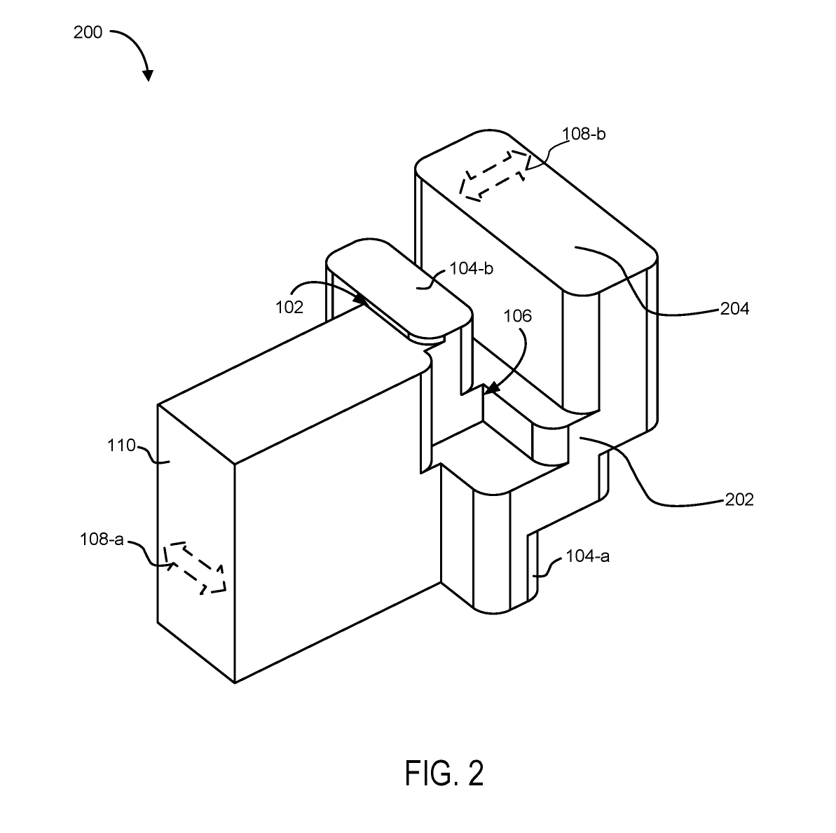

FIG. 2 is an assembled view of the waveguide apparatus 200 with the waveguide twist (e.g., shown in FIG. 1) in addition to a waveguide bend. The bend in the waveguide changes a direction of propagation of the waveguide. When combined with the waveguide twist structure of FIG. 1, both the propagation direction and polarization of the electromagnetic wave is rotated by 90 degrees when it passes through the waveguide apparatus.

In some embodiments, the input port 102 matches to (e.g., is coupled with or receives) a first waveguide 110. In some embodiments, the waveguide 110 has a rectangular cross-section that matches the cross-section of the input port in the plane perpendicular to a direction of propagation. For example, a transmitted wave may travel through first waveguide 110, through the input port 102, and continue through the waveguide apparatus.

In some embodiments, the output port 106 matches to (e.g., is coupled with or receives) a second waveguide 204 through a waveguide bend 202. In some embodiments, the second waveguide 204 has a rectangular cross-section configured to transmit a wave along a direction of propagation distinct from the direction of propagation along the first waveguide 110. For example, as shown in FIG. 2, the first waveguide 110 has a direction of propagation in a horizontal plane while the second waveguide 204 has a vertical direction of propagation. In some embodiments, the second waveguide 204 also has a polarization distinct from a polarization of the first waveguide 110 (e.g., the polarization of the first waveguide 110 is along the short side of the first waveguide 110 and the polarization of the second waveguide 204 is along the short side of the second waveguide 204, which is perpendicular to the first). In some embodiments, second waveguide 204 has a rectangular cross-section with a short side and a long side, wherein the short side of the second waveguide's cross-section is perpendicular to the short side of the input port's (e.g., input port 102) cross-section and the short side of the output port's cross-section.

In some embodiments, the waveguide bend 202 couples the output port 106 with the second waveguide 204. In some embodiments, the waveguide bend 202 is configured to change a direction of propagation of a transmitted wave. In some embodiments, the waveguide bend 202 is configured to change a direction of propagation of a transmitted wave by 90 degrees.

For example, a transmitted wave having a first horizontal polarization 108-a may travel through the first waveguide 110 and through the input port 102. As the wave travels through a waveguide twist (e.g., the plurality of cavities 104-a and 104-b), both the horizontal and vertical polarizations of the transmitted wave are excited in the first cavity 104-a and the second cavity 104-b in order to change the direction of polarization to have second polarization 108-b. After traveling through the waveguide twist, the transmitted wave also passes through waveguide bend 202, which changes the direction of propagation of the wave (e.g., by 90 degrees).

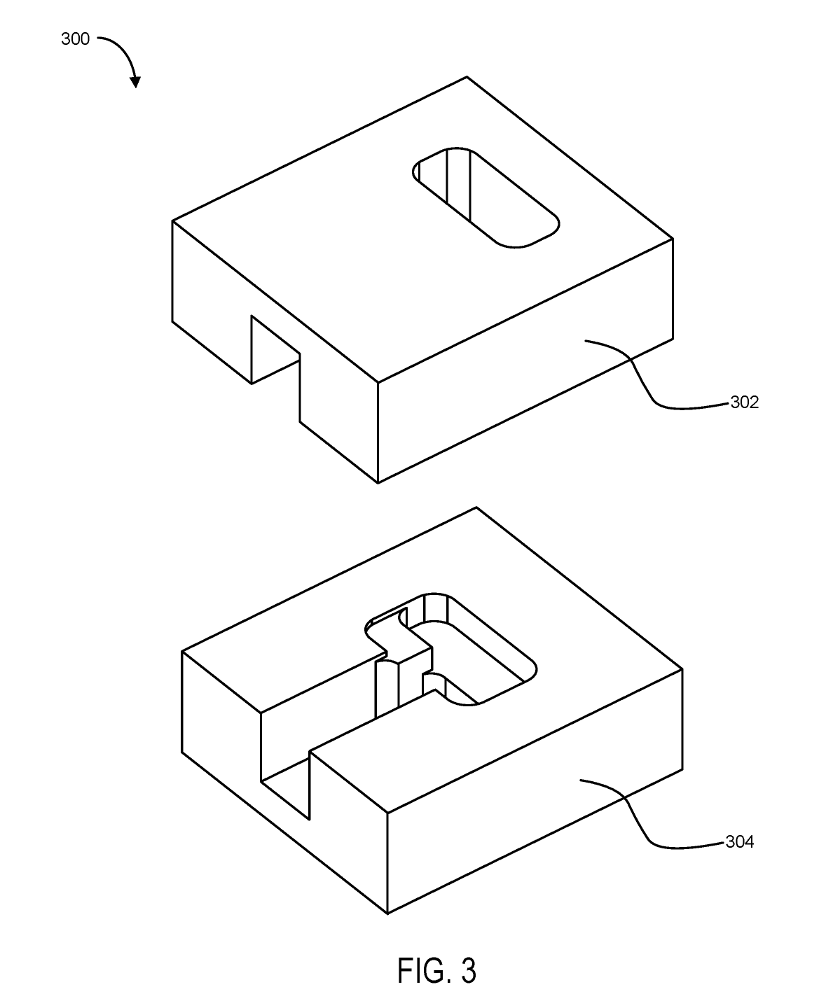

FIG. 3 depicts waveguide components 302 and 302, which, when mated together, form waveguide apparatus 300.

Waveguide apparatus 300 is analogous to waveguide apparatus 200 (FIG. 2). In particular, FIG. 3 illustrates that the waveguide apparatus shown in FIG. 2 can be formed from negative space in a pair of waveguide components mated together. In some embodiments, the negative space can be removed from metal blocks using a standard (e.g., conventional) milling process. For example, to fabricate waveguide apparatus, an aluminum (or copper) block may be cut in two. The features describes with respect to FIG. 1 and FIG. 2 can be milled into the two blocks, so that the features are fully-formed when the two blocks are assembled together (e.g., by screwing the two parts). In some embodiments, the interior corners that form the waveguide (e.g., the plurality of cavities) are milled with a radius of 1 mm. Therefore, the fabrication of the waveguide apparatus is efficient and simple enough for mass production.

The description of the present application has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

The terminology used in the description of the embodiments herein is for the purpose of describing particular embodiments only and is not intended to limit the scope of claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will also be understood that, although the terms first, second, etc. may be used herein to describe various elements, these elements should not be limited by these terms. These terms are only used to distinguish one element from another. For example, a first port could be termed a second port, and, similarly, a second port could be termed a first port, without departing from the scope of the embodiments. The first port and the second port are both ports, but they are not the same port.

Many modifications and alternative embodiments of the embodiments described herein will come to mind to one skilled in the art having the benefit of the teachings presented in the foregoing descriptions and the associated drawings. Therefore, it is to be understood that the scope of claims are not to be limited to the specific examples of the embodiments disclosed and that modifications and other embodiments are intended to be included within the scope of the appended claims. Although specific terms are employed herein, they are used in a generic and descriptive sense only and not for purposes of limitation.

The embodiments were chosen and described in order to best explain the underlying principles and their practical applications, to thereby enable others skilled in the art to best utilize the underlying principles and various embodiments with various modifications as are suited to the particular use contemplated.

1. A waveguide apparatus, comprising:
an input port having a rectangular cross-section in a plane perpendicular to a direction of propagation, the rectangular cross-section having a short side and a long side;
a plurality of resonant cavities coupled with the input port, the plurality of resonant cavities including a first resonant cavity and a second resonant cavity, the first resonant cavity and the second resonant cavity being diagonally disposed with respect to each other in the plane perpendicular to the direction of propagation, each resonant cavity having a square cross-section in the plane perpendicular to the direction of propagation; and
an output port coupled with the plurality of resonant cavities on a side opposite the input port, the output port having a rectangular cross-section with a short side and a long side, wherein the short side of the output port's cross-section is perpendicular to the short side of the input port's cross-section, wherein the input port is configured to receive a TE10 mode and the output port is configured to output a TE10 mode that is rotated with respect to the input port.

2. (canceled)

3. The waveguide apparatus of claim 1, further comprising:
a first waveguide coupled with the input port, the first waveguide having a rectangular cross-section that matches the input port;
a second waveguide coupled with the output port, the second waveguide having a rectangular cross-section configured to transmit a wave along a direction of propagation distinct from the direction of propagation along the first waveguide, and with a polarization distinct from a polarization of the first waveguide; and
a waveguide bend coupling the output port with the second waveguide, the waveguide bend configured to change the direction of propagation of the transmitted wave.

4. The waveguide apparatus of claim 3, wherein the waveguide bend is configured to change the direction of propagation by 90 degrees.

5. The waveguide apparatus of claim 1, wherein the plurality of resonant cavities forms a waveguide twist.

6. The waveguide apparatus of claim 5, wherein the waveguide twist changes a polarization of a transmitted wave by 90 degrees.

7. The waveguide apparatus of claim 5, wherein a length of the waveguide twist is less than a wavelength of a transmitted wave at the waveguide apparatus's operating frequency.

8. The waveguide apparatus of claim 5, wherein the waveguide apparatus has dimensions smaller than 1 mm×11 mm×10 mm.

9. The waveguide apparatus of claim 1, wherein the input port, the plurality of resonant cavities, and the output port are formed from negative space in a pair of waveguide components mated together.
